(19) United States
(12) Patent Application Publication
(10) Pub. No.: US 2017/0280044 A1
(43) Pub. Date: Sep. 28, 2017

(54) SENSOR MANAGEMENT SYSTEM, SENSOR MANAGEMENT DEVICE, SENSOR DEVICE, SENSOR MANAGEMENT METHOD, AND PROGRAM

(71) Applicant: NEC Corporation, Tokyo (JP)

(72) Inventor: Jun KOBAYASHI, Tokyo (JP)

(73) Assignee: NEC Corporation, Tokyo (JP)

(21) Appl. No.: 15/510,723

(22) PCT Filed: Sep. 8, 2015
(86) PCT No.: PCT/JP2015/075490

§ 371 Date: Mar. 13, 2017

(30) Foreign Application Priority Data
Sep. 19, 2014 (JP) 2014-191432

(51) Int. Cl. H04N 5/232; H04R 1/02; H04R 29/00; H04N 7/18

(52) U.S. Cl. CPC H04N 5/23206; H04N 7/181; H04R 1/028; H04R 29/00

(57) ABSTRACT

A sensor device and a sensor management device are provided. The sensor management device transmits a change-of-use signal to the sensor device in a case where a use of the sensor device is changed, and the sensor device acquires data based on the change-of-use signal. Preferably, the sensor management device acquires a processing request for instructing the use of the sensor device, and automatically generates the change-of-use signal based on the processing request.

### TECHNICAL FIELD

The present invention relates to a sensor management system, a sensor management device, a sensor device, a sensor management method, and a program.

### BACKGROUND ART

Technology for searching for missing children using a plurality of cameras has been proposed.

For example, the person search system disclosed in Patent Document 1 has a plurality of monitor cameras set at a plurality of locations in a facility, a plurality of monitoring terminals, and a server. The video footage of the monitor cameras is stored in the server.

When a facial image of a missing child is input via a reading device of the monitoring terminal, it is transmitted to the server as search request information along with the search period and complementary information whose input is accepted through a data input portion.

The server collates the facial image of the search request information with the facial image of a person in the stored footage, extracts footage in which the missing child appears and transmits it to the monitoring terminal.

The monitoring terminal displays the retrieval result through a display portion.

In Patent Document 1, thereby it is assumed that it is possible to be able to easily search a specific person from a large number of people in a short time.

### PRIOR ART DOCUMENTS

### Patent Document

[Patent Document 1] Japanese Unexamined Patent Application, First Publication No. 2004-126711

### SUMMARY OF INVENTION

### Problem to be Solved by the Invention

When applying such a system that searches for a missing child using cameras to a wide range such as all areas of a shopping mall or the entire building of a department store, many cameras are required. When the number of cameras to be installed for the system increases, since the cost of installing the cameras rises, the installation cost of the system increases.

In a system that acquires information over a wide area using sensors in this manner, the number of sensors required increases. When the number of sensors installed for the system increases, since the cost of installing the sensors rises, the installation cost of the system increases.

The present invention has as its object to provide a sensor management system, a sensor management device, a sensor device, a sensor management method, and a program that can solve the aforementioned issues.

### Means for Solving the Problem

The present invention provides a sensor management system including: a sensor device; and a sensor management device, wherein the sensor management device transmits a change-of-use signal to the sensor device in a case where a use of the sensor device is changed, and the sensor device acquires data based on the change-of-use signal.

The present invention also provides a sensor management device including: a change-of-use signal transmission unit that transmits a change-of-use signal to a sensor device in a case where a use of the sensor device is changed.

The present invention also provides a sensor device that, upon receiving a change-of-use signal instructing a change of use, acquires data based on the change-of-use signal.

The present invention also provides a sensor management method including: a change-of-use signal transmission step of transmitting, by a sensor management device, a change-of-use signal to a sensor device in a case where a use of the sensor device is changed.

The present invention also provides a program that causes a computer to execute: a change-of-use signal transmission step of transmitting a change-of-use signal to a sensor device in a case where a use of the sensor device is changed.

### Effect of the Invention

According to the present invention, it is possible to lower the cost of installing a sensor used in a sensor management system.

### BRIEF DESCRIPTION OF THE DRAWINGS

FIG. 1 is an outline block diagram that shows a function configuration of a missing child search system in a first exemplary embodiment of the present invention.

FIG. 2 is a flowchart that shows an example of the procedure in which the missing child search system in the same exemplary embodiment performs a missing child search.

FIG. 3 is an outline block diagram that shows a function configuration of a missing child search system in a second exemplary embodiment of the present invention.

FIG. 4 is an outline block diagram that shows a function configuration of a missing child search system in a third exemplary embodiment of the present invention.

FIG. 5 is an outline block diagram that shows a minimum configuration of a sensor management system of the present invention.

FIG. 6 is an outline block diagram that shows a minimum configuration of a sensor management device of the present invention.

FIG. 7 is an outline block diagram that shows a minimum configuration of a sensor device of the present invention.

### EXEMPLARY EMBODIMENTS FOR CARRYING OUT THE INVENTION

Hereinbelow exemplary embodiments of the present invention will be described, but the following exemplary embodiments do not limit the invention according to the claims. Furthermore, all of the combinations of the characteristics described in the exemplary embodiments are not necessarily essential for the solving means of the present invention.

### First Exemplary Embodiment

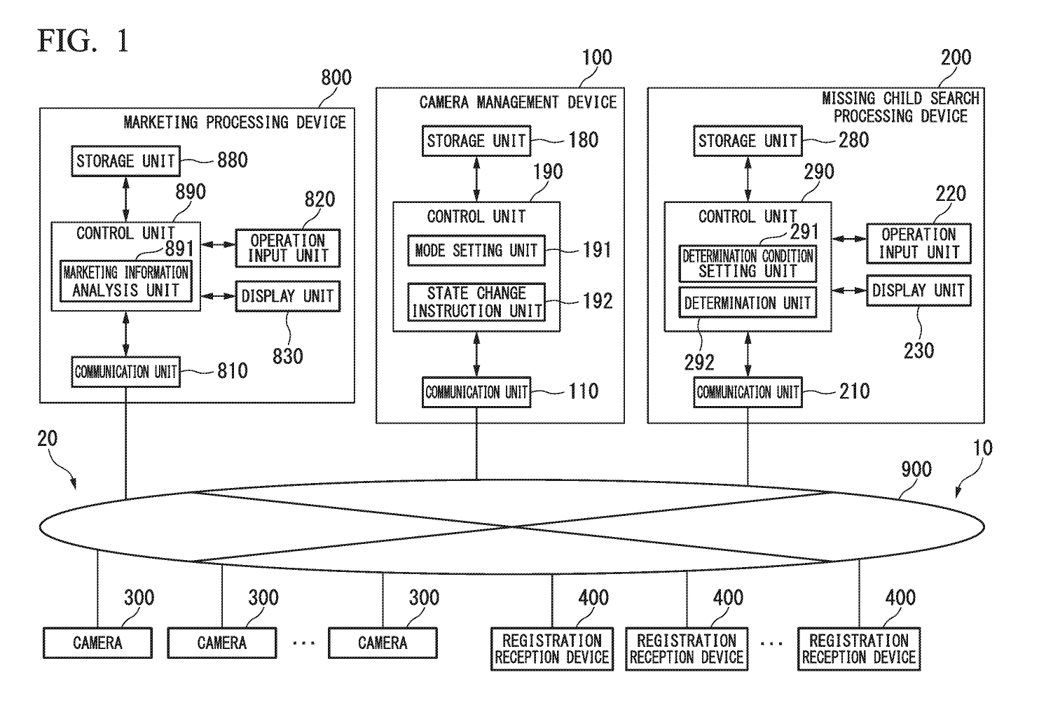

FIG. 1 is an outline block diagram that shows a function configuration of a missing child search system in a first exemplary embodiment of the present invention.

In the same figure, a missing child search system 10 includes a camera management device 100, a missing child search processing device 200, one or more cameras 300, and one or more registration reception devices 400.

The camera management device 100 includes a communication unit 110, a storage unit 180, and a control unit 190. The control unit 190 includes a mode setting unit 191 and a state change instruction unit 192.

The missing child search processing device 200 includes a communication unit 210, an operation input unit 220, a display unit 230, a storage unit 280, and a control unit 290. This control unit 290 includes a determination condition setting unit 291 and a determination unit 292.

The camera management device 100, the missing child search processing device 200, the camera 300, and the registration reception device 400 are connected to a network 900.

Note that the missing child search system 10 corresponds to an example of a sensor management system.

Moreover, a marketing processing device 800 is also connected to the above-mentioned network 900.

The marketing processing device 800 includes a communication unit 810, an operation input unit 820, a display unit 830, a storage unit 880, and a control unit 890. This control unit 890 includes a marketing information analysis unit 891.

A marketing processing system 20 is constituted by the marketing processing device 800 and the camera 300 being connected to the network 900.

For example, the missing child search system 10 may be installed using the existing marketing processing system 20. Alternatively, both the missing child search system 10 and the marketing processing system 20 may be established newly.

The camera 300 captures images for acquiring marketing information in the marketing processing system 20. Marketing information here is information that is useful in decision making in sales.

For example, the camera 300 is installed on the ceiling above a shelf space and captures images of the shelf space from above pointing down. Thereby, it is possible to capture an image of the action in which a customer takes merchandise in his hand. If the merchandise that a customer takes in his hand is known, even for merchandise that is not purchased, it is possible to ascertain what kinds of merchandise customers are interested in. Moreover, when the customer is included in the image of the camera 300, it is possible to ascertain from the image the number of customers that have visited a particular shelf space, attributes such as the age and sex of a customer, and customer behavior.

Note that in addition to or in place of the camera 300 that captures images of shelf space, the camera 300 that images the entire aisle in a store may be provided. From the images of the camera 300 that images an entire aisle in a store, it is possible to ascertain traffic lines in which customers move in the store.

Moreover, in the missing child search system 10, the camera 300 captures images for searching for a missing child. For example, the camera 300 captures images of the aisle in a store. When a child who goes missing (hereinbelow called a missing child) passes through an aisle, due to the camera 300 capturing an image of that child, as described below, the missing child search processing device 200 can detect the location of the missing child.

The camera 300 corresponds to an example of a sensor device, and by performing imaging on the basis of a change-of-use signal from the camera management device 100, outputs image data. More specifically, the camera 300 changes the state of the camera 300 itself on the basis of a change-of-use signal from the camera management device 100, and in the state following the change, performs image capture and outputs image data. A sensor here is a device that converts information related to an object into an electrical signal.

For example, when the camera 300 which is capturing images of a shelf for marketing information acquisition acquires a change-of-use signal which instructs image capture for a missing child search, the camera 300 changes its own direction so as to image an aisle. In this case, the direction of the camera 300 corresponds to the example of the above-mentioned state of the camera 300.

Alternatively, when the camera 300 which is capturing images of a shelf for marketing information acquisition acquires a change-of-use signal which instructs image capture for a missing child search, the camera 300 may widen the angle of view to capture an image of a range including the aisle. In this case, the angle of view of the camera 300 corresponds to the example of the above-mentioned state of the camera 300.

Alternatively, when the camera 300 which is capturing images of an entire aisle for marketing information acquisition acquires a change-of-use signal which instructs image capture for a missing child search, the camera 300 may be made to perform imaging with increased resolution. During the acquisition of marketing information, imaging may be performed with a comparatively lower resolution out of respect for customer privacy, while during a search for a missing child, imaging may be performed with a comparatively higher resolution so as to be able to specify the child. In this case, the resolution corresponds to the example of the aforementioned state of the camera 300.

Note that the number of cameras 300 may be one or more.

The registration reception device 400 receives a determination information registration operation. Determination information referred to here is information used for the setting of a determination condition with respect to data output by a sensor device. A determination condition referred to here is a condition for which a determination is performed as to whether or not the condition is satisfied.

In the present exemplary embodiment, the registration reception device 400 acquires information for specifying a missing child as determination information. For example, the registration reception device 400 acquires a missing child's image data, and extracts any one or a plurality among information showing facial characteristics, information showing body characteristics such as height, and information showing characteristics of clothing such as shirt color.

Alternatively, the registration reception device 400 may be made to acquire determination information of a data format other than image data in addition to or in place of image data, such as receiving an input operation in natural language instructing the color of the missing child's shirt.

It is possible to use various devices as the above-mentioned registration reception device 400. For example, the registration reception device 400 may be realized using touch-sensitive digital signage that is installed as a floor guide.

For example, the registration reception device 400 displays a “search for missing child” button, and when that button is pressed, the registration reception device 400 displays a message urging that a photograph of the missing child be transmitted by short-distance wireless communication. Then, the registration reception device 400 acquires, as determination information, image data of the missing child that the person requesting a missing child search (for example, a parent of the missing child) has transmitted from a smartphone or the like in accordance with the message.

Alternatively, the registration reception device 400 may be realized using a POS (Point Of Sale) register. In this case, for example a salesclerk who has received a request for a missing child search operates the registration reception device 400 to put the registration reception device 400 in a state of being able to communicate with a smartphone or the like. The registration reception device 400 acquires, as determination information, image data of the missing child that the person requesting a missing child search has transmitted from a smartphone or the like.

Note that the number of the registration reception devices 400 may be one or more.

The marketing processing device 800 acquires marketing information from the images captured by the camera 300. The marketing processing device 800 is realized, for example using a computer.

The communication unit 810 performs communication with other devices through the network 900. In particular, the communication unit 810 receives images captured by the camera 300 as image data.

The operation input unit 820 has an input device such as for example a mouse or a keyboard, and receives user operations. For example, the operation input unit 820 receives a user input operation with respect to a process of the marketing processing devices 800, such as setting the type of marketing information that the marketing processing device 800 acquires.

The display unit 830 includes a display screen such as a liquid crystal panel, and displays various images. In particular, the display unit 830 displays marketing information that the marketing processing device 800 has acquired.

The storage unit 880 is realized using a storage device which the marketing processing device 800 is equipped with, and stores various types of data. For example, the storage unit 880 stores images captured by the camera 300 for a predetermined time from the most recent going back to the past.

The control unit 890 controls each part of the marketing processing device 800 to perform various processing. The control unit 890 is realized, for example, by a CPU (Central Processing Unit) that the marketing processing device 800 has reading out and executing a program from the storage unit 880.

The marketing information analysis unit 891 analyzes images captured by the camera 300 to acquire marketing information. For example, the marketing information analysis unit 891 analyzes an image of the shelf space captured by the camera 300 from above facing downward, and determines attributes such as the age and sex of a customer who appears in the image.

The missing child search processing device 200 corresponds to an example of a determination device, and determines whether or not the image which the camera 300 captured after the state change fulfills the conditions that have been set based on the determination information from the registration reception device 400. Specifically, the missing child search processing device 200 determines whether or not the missing child appears in the image which the camera 300 captured for a missing child search. The missing child search processing device 200 is realized, for example using a computer.

The communication unit 210 communicates with other devices through the network 900. In particular, the communication unit 210 receives the image which the camera 300 has captured as image data. Moreover, the communication unit 210 receives the determination information which the registration reception device 400 has acquired.

The operation input unit 220 has for example an input device such as a mouse or a keyboard and receives user operations. For example, the operation input unit 220 receives a user input operation that performs a setting for a process of the missing child search processing devices 200 such as a user input operation specifying a camera 300 and a time and requesting the display of an image.

The display unit 230 has a display screen, such as a liquid crystal panel, and displays various images. In particular, the display unit 230 displays information about a missing child detected by the missing child search processing device 200 on the basis of the image captured by the camera 300, such as location information of the missing child.

The storage unit 280 is realized using the storage device which the missing child search processing device 200 includes, and stores various types of data. For example, the storage unit 280 stores the above-mentioned determination information and images captured by the camera 300.

The control unit 290 controls each part of the missing child search processing device 200 to perform various processes. The control unit 290 is realized, for example, by the CPU which the missing child search processing device 200 has reading out and executing a program from the storage unit 280.

The determination condition setting unit 291 sets the condition of a determination which the determination unit 292 performs based on the above-mentioned determination information. Specifically, the determination condition setting unit 291, based on the image of a missing child provided as determination information, sets a determination condition for determining whether or not the missing child appears in the image of the camera 300.

The determination unit 292 determines whether or not the missing child appears in the image of the camera 300 based on the determination condition set by the determination condition setting unit 291.

The camera management device 100 corresponds to an example of the sensor management device and transmits a change-of-use signal to a camera 300 when changing the use of the camera 300. More specifically, the camera management device 100, upon receiving a processing request, transmits a change-of-use signal to the camera 300 in accordance with the processing request.

Still more specifically, when the registration reception device 400 receives a user input operation requesting a missing child search and transmits a missing child search processing request, the camera management device 100 that has received the processing request automatically generates a change-of-use signal that instructs a camera 300 to set the direction thereof for a missing child search and capture images, and transmits it to the camera 300.

The camera management device 100 is realized using for example a computer.

The communication unit 110 communicates with other instruments through the network 900.

In particular, the communication unit 110 corresponds to an example of a processing request acquisition unit, and receives the missing child search processing request from the registration reception device 400.

Moreover, the communication unit 110 corresponds to an example of a change-of-use signal transmission unit, and transmits a change-of-use signal to the camera 300. Specifically, the communication unit 110 transmits a state change instruction to the camera 300 as a change-of-use signal.

The storage unit 180 is realized using the storage device with which the camera management device 100 is equipped and stores various types of data. For example, the storage unit 180 stores the respective signals transmitted to the camera 300 at the time at which a missing child search begins and the time at which a missing child search ends.

The control unit 190 controls each part of the camera management device 100 to perform various processes. The control unit 190 is realized, for example, by the CPU which the camera management device 100 has reading out a program from the storage unit 180 and executing it.

The mode setting unit 191 sets the mode that causes the camera 300 to capture an image. In the present exemplary embodiment, a marketing information acquisition mode and a missing child search mode are modes which the mode setting unit 191 sets. The marketing information acquisition mode is a mode in which the camera 300 performs image capture for marketing information acquisition. On the other hand, the missing child search mode is a mode in which the camera 300 performs image capture for a missing child search.

Normally, the mode setting unit 191 sets the camera 300 to the marketing information acquisition mode. On the other hand, upon receiving a missing child search processing request from the registration reception device 400, the mode setting unit 191 switches to the missing child search mode. When the missing child is discovered, the mode setting unit 191 returns to the marketing information acquisition mode.

The state change instruction unit 192 instructs a change of state to the camera 300 based on the mode set by the mode setting unit 191. The camera 300 may have stored in advance a program for a state change, and by executing the program on the basis of the instruction from the camera management device 100, may change the state of the camera 300 itself.

Alternatively, the camera management device 100 may transmit as a signal instructing a change of state to the camera 300 a program to be executed by the camera 300. The camera 300 may update its own program with a program received from the camera management device 100. Thereby, it is possible to have the camera 300 perform an operation that was not planned at the time of installation of the camera 300.

The network 900 mediates communication between each device. The network 900 may be a dedicated communication network of the missing child search system 10 and marketing processing system 20. Alternatively, the network 900 may for example be a general-purpose network such as the Internet or a LAN (Local Area Network).

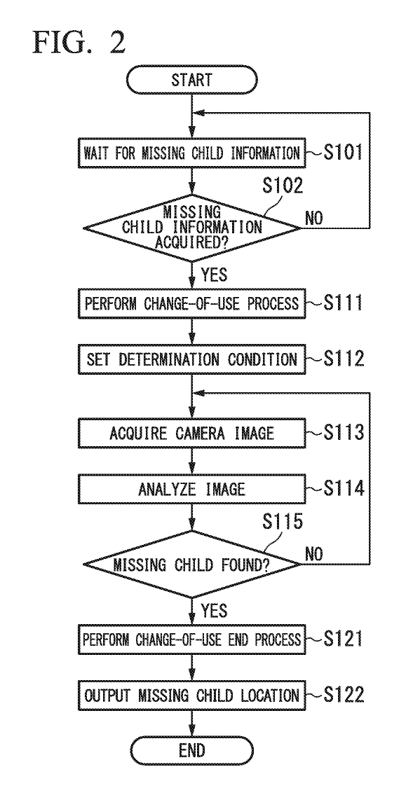

Next, the operation of the missing child search system 10 shall be described referring to FIG. 2. FIG. 2 is a flowchart that shows an example of the procedure in which the missing child search system 10 performs a missing child search.

The missing child search system 10 starts the process of the same figure when the registration reception device 400 receives a request to start a missing child search, such as receiving a touch operation to a “search for missing child” button as mentioned above.

In the process of FIG. 2, the registration reception device 400 waits for information for specifying a missing child (Step S101). For example, the registration reception device 400 waits for transmission of image data of a missing child as described above. Note that information for specifying a missing child is called missing child information. Missing child information corresponds to an example of determination information.

Next, the registration reception device 400 determines whether or not it has acquired missing child information (Step S102). When it determines that missing child information has not been acquired (Step S102: NO), the process returns to Step S101.

On the other hand, when it determines that the missing child information has been acquired (Step S102: NO), the camera management device 100 performs a process of changing the use of the camera 300 (Step S111).

Specifically, the registration reception device 400 transmits a processing request for a missing child search to the camera management device 100. In the camera management device 100, when the communication unit 110 receives the processing request, the mode setting unit 191 sets the mode for causing the camera 300 to capture images to the missing child search mode. The state change instruction unit 192 instructs a change of state to the camera 300 based on the mode set by the mode setting unit 191. The camera 300 which has received the instruction changes the state of the camera 300 itself and starts capturing an image for a missing child search.

Moreover, the missing child search processing device 200 sets a determination condition for detecting a missing child (Step S112). Specifically, the registration reception device 400 transmits missing child information to the missing child search processing device 200.

In the missing child search processing device 200, when the communication unit 210 receives the missing child information, the determination condition setting unit 291 analyzes the missing child information to set a determination condition for whether or not the missing child that is the search object appears.

Next, a camera 300 captures an image for the missing child search, and transmits it as image data to the missing child search processing device 200, and the communication unit 210 of the missing child search processing device 200 receives the image data (Step S113).

The determination unit 292 analyzes the image obtained in Step S113 (Step S114).

Furthermore, the determination unit 292 determines whether or not the missing child appears in the image obtained in Step S113 by comparing the result of the aforementioned analysis and the determination condition set in Step S112 (Step S115).

When it determines that the missing child does not appear (Step S115: NO), the process returns to step S113.

On the other hand, in Step S115, when it determines that the missing child appears (Step S115: YES), the camera management device 100 performs a process that ends the change of use of the camera 300 (Step S121).

Specifically, the mode setting unit 191 returns the mode of causing the camera 300 to perform imaging to the marketing information acquisition mode. The state change instruction unit 192 instructs a change of state to the camera 300 on the basis of the mode set by the mode setting unit 191.

The camera 300 which has received the instruction changes the state of camera 300 itself and starts capturing images for marketing information acquisition.

Furthermore, the missing child search processing device 200 outputs missing child location information (Step S122). Missing child location information referred to here is information which shows a missing child's location.

For example, the display unit 230 displays the image in which the missing child was determined by the determination unit 292 to appear. The user can ascertain the missing child's location by referring to the background in the image displayed by the display unit 230.

Alternatively, in addition to displaying the image captured by the camera 300, the display unit 230 may display information other than the image. For example, the display unit 230 may display information for identifying the camera 300 that captured the image (for example, an identification number assigned in advance to the camera 300).

Alternatively, the camera management device 100 may output missing child location information by a method other than the display unit 230 displaying missing child location information. For example, in addition to or instead of display of missing child location information by the display unit 230, the communication unit 110 may transmit missing child location information to other devices. Alternatively, the camera management device 100 may include a loudspeaker and output with a voice the name of the area at which the missing child has been discovered.

After Step S122, the process of FIG. 2 ends. After the end of the process of FIG. 2, the camera 300 captures an image for marketing information acquisition based on the marketing information acquisition mode that has been set. The marketing information analysis unit 891 of the marketing processing device 800 analyzes the image to acquire marketing information.

As mentioned above, the camera management device 100 transmits a change-of-use signal to the camera 300 when changing the use of the camera 300. The camera 300 performs image capture and acquires image data on the basis of the change-of-use signal.

More specifically, the camera management device 100, upon receiving a processing request, transmits a change-of-use signal to the camera 300 in accordance with the processing request. The camera 300 changes the state of the camera 300 itself based on the change-of-use signal, and in the state following the change, performs image capture to obtain image data.

In this way, by the camera 300 changing the state of the camera 300 itself in accordance with the use, it is possible to use the existing camera 300 for the marketing processing system 20 for the missing child search system 10. Accordingly, it is possible to reduce the cost of installing the camera 300 used in the missing child search system 10.

Moreover, the camera management device 100 acquires a processing request, and generates a change-of-use signal automatically based on the processing request.

By the camera management device 100 automatically generating a change-of-use signal in this way, a user of the missing child search system 10 can use the camera 300 for a missing child search without the trouble of giving an instruction for a concrete action to the camera 300.

Moreover, the missing child search processing device 200 acquires determination information, and determines whether or not image data obtained by the camera 300 after the state change satisfies the condition set on the basis of the determination information.

In this way, the missing child search system 10, using the existing camera 300 in the marketing processing system 20, can perform a process of determining whether or not the image captured by the camera 300 satisfies a condition. Thereby, while decreasing the cost of installing cameras 300 to be used in the missing child search system 10, it is possible to perform an automatic determination process such as the determination of whether or not for example a missing child appears in an image.

Moreover, the registration reception device 400 receives a determination information registration operation.

Thereby, in the missing child search system 10, it is possible to set a determination condition in accordance with a processing object, such as a determination condition based on for example a characteristic of a missing child.

Moreover, the missing child search system 10 includes the camera 300 as a sensor device, and outputs image data.

Thereby, in the missing child search system 10, it is possible to use the camera 300 that performs image capture for the marketing processing system 20 for the use of a missing child search, and it is possible to reduce the cost of installing the camera 300 used for the missing child search system 10.

Change of the state of the camera 300 is not limited to a change of the direction of the camera 300. For example, in addition to or instead of a change of the direction of the camera 300, the angle of view of the camera 300 may be changed. Specifically, the camera 300 may capture an image of the vicinity of a shelf with a comparatively narrow angle of view in the marketing process mode, while the camera 300 may capture an image of a broader range with a comparatively wider angle of view in the missing child search mode.

Alternatively, the resolution of the camera 300 may be lowered for privacy protection in the marketing process mode, while the resolution of the camera 300 may be raised so as to be able to recognize the face of a missing child in the missing child search mode.

Alternatively, the image of the camera 300 may be discarded in a comparatively short time for privacy protection in the marketing process mode, while the image of the camera 300 may be saved for a comparatively long time, so as to be able to confirm the image, in the missing child search mode.

### Second Exemplary Embodiment

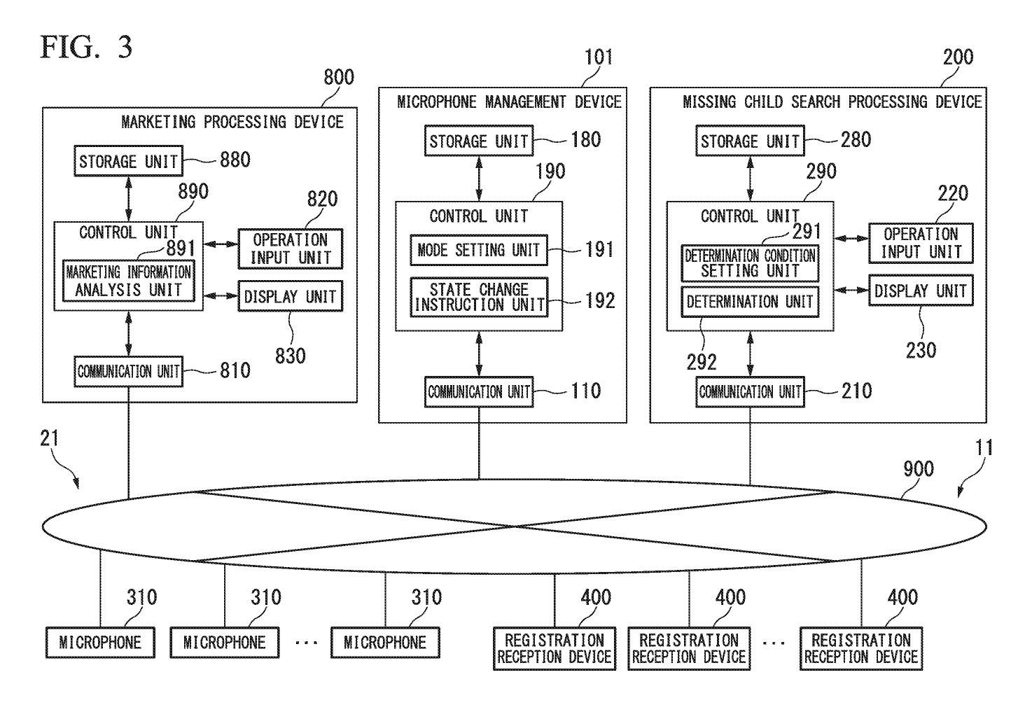

FIG. 3 is an outline block diagram that shows a function configuration of a missing child search system in a second exemplary embodiment of the present invention.

In the same figure, a missing child search system 11 includes a microphone management device 101, a missing child search processing device 200, one or more microphones 310, and one or more registration reception devices 400.

The microphone management device 101 includes a communication unit 110, a storage unit 180, and a control unit 190. This control unit 190 includes a mode setting unit 191 and a state change instruction unit 192.

The missing child search processing device 200 includes a communication unit 210, an operation input unit 220, a display unit 230, a storage unit 280, and a control unit 290. This control unit 290 includes a determination condition setting unit 291 and a determination unit 292.

The microphone management device 101, the missing child search processing device 200, the microphone 310, and the registration reception device 400 are connected to the network 900.

Note that the missing child search system 11 corresponds to an example of a sensor management system.

Moreover, the number of microphones 310 may be one or more.

Moreover, the marketing processing device 800 is also connected to the above-mentioned network 900.

The marketing processing device 800 includes a communication unit 810, an operation input unit 820, a display unit 830, a storage unit 880, and a control unit 890. This control unit 890 includes a marketing information analysis unit 891.

A marketing processing system 21 is constituted by the marketing processing device 800 and the microphone 310 being connected to the network 900.

For example, the missing child search system 11 may be installed using the existing marketing processing system 21. Alternatively, both the missing child search system 11 and the marketing processing system 21 may be established newly.

In FIG. 3, those portions having the same functions with respect to the portions of FIG. 1 are denoted by the same reference symbols (110, 180, 190-192, 200, 210, 220, 230, 280, 290-292, 400, 800, 810, 820, 830, 880, 890, 891, 900), with descriptions thereof being omitted.

In FIG. 3, the microphone 310 is provided in place of the camera 300 in FIG. 1. In the marketing process mode, the microphone 310 has directionality, and, for example, collects conversations of customers in front of a shelf. The marketing information analysis unit 891 analyzes the conversations which the microphone 310 collected to acquire marketing information.

On the other hand, in the missing child search mode, the microphone 310 broadens the sound collection target range (that is, eliminates or weakens directionality), and collects sound in a broader range than the case of the marketing process mode. In this case, in Step S111 of FIG. 2, the state change instruction unit 192, on the basis of the mode set by the mode setting portion 191, gives an instruction to the microphone 310 so as to broaden the sound collection target range.

In addition, in Step S112, the determination condition setting unit 291 acquires for example audio data of a missing child to set a determination condition for determining whether or not it is the voice of the missing child.

Moreover, in Step S113, the communication unit 210 receives the sounds collected by the microphone 310 as audio data. In Step S114, the determination unit 292 analyzes the audio obtained in Step S113. Furthermore, in Step S115, the determination unit 292 compares the analysis result and the determination condition to determine whether or not the voice of the missing child is included in the audio obtained by the microphone 310.

Also, in Step S121, the state change instruction unit 192, on the basis of the mode set by the mode setting unit 191, instructs the microphone 310 to restore the sound collection target range.

Moreover, in the output of the missing child location information in Step S122, the display unit 230 displays information for identifying the microphone 310 which for example collected the voice of the missing child.

As mentioned above, the missing child search system 11 includes a microphone 310 as a sensor device to output sound data.

Thereby, in the missing child search system 11, it is possible to use the microphone 310 which collects sounds for the marketing processing system 21 for the use of a missing child search, and it is possible to reduce of cost of separately installing the microphone 310 used in the missing child search system 11.

### Third Exemplary Embodiment

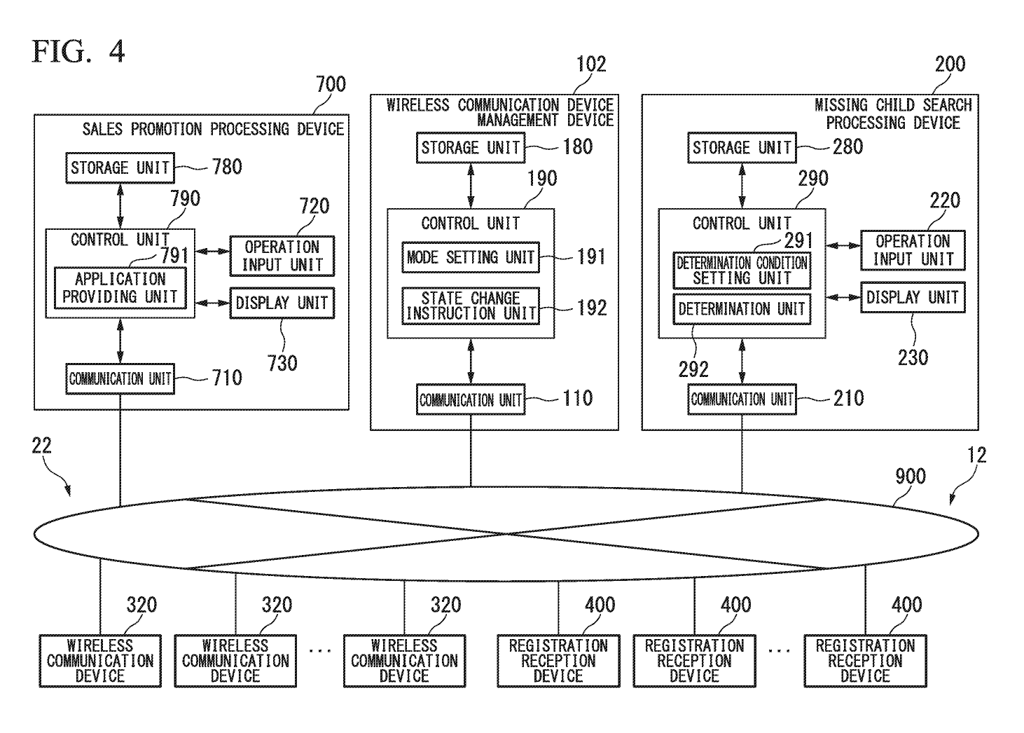

FIG. 4 is an outline block diagram that shows a function configuration of a missing child search system in a third exemplary embodiment of the present invention.

In the same figure, a missing child search system 12 includes a wireless transmission device management device 102, a missing child search processing device 200, one or more wireless transmission devices 320, and one or more registration reception devices 400.

The wireless transmission device management device 102 includes a communication unit 110, a storage unit 180, and a control unit 190. This control unit 190 includes a mode setting unit 191 and a state change instruction unit 192.

The missing child search processing device 200 includes a communication unit 210, an operation input unit 220, a display unit 230, a storage unit 280, and a control unit 290. This control unit 290 includes a determination condition setting unit 291 and a determination unit 292.

The wireless transmission device management device 102, the missing child search processing device 200, the wireless transmission device 320, and the registration reception device 400 are connected to the network 900.

Note that the missing child search system 12 corresponds to an example of a sensor management system.

Moreover, the number of wireless transmission devices 320 may be one or more.

Moreover, a sales promotion processing device 700 is also connected to the above-mentioned network 900.

The sales promotion processing device 700 includes a communication unit 710, an operation input unit 720, a display unit 730, a storage unit 780, and a control unit 790. This control unit 790 includes an application providing unit 791.

A sales promotion processing system 22 is constituted by the sales promotion processing device 700 and the wireless communication device 320 being connected to the network 900.

For example, the missing child search system 12 may be installed using the existing sales promotion processing system 22. Alternatively, both the missing child search system 12 and the sales promotion processing system 22 may be established newly.

In FIG. 4, those portions having the same functions with respect to the portions of FIG. 1 are denoted by the same reference symbols (110, 180, 190-192, 200, 210, 220, 230, 280, 290-292, 400, 900) with descriptions thereof being omitted.

In FIG. 4, the wireless communication device 320 is provided in place of the camera 300 in FIG. 1.

Also, in FIG. 4, the sales promotion processing device 700 is provided in place of the marketing processing device 800 in FIG. 1. The sales promotion processing device 700 provides an application (application program) for sales promotion.

In the present exemplary embodiment, a sales promotion processing mode and a missing child search mode are modes which the mode setting unit 191 sets.

The sales promotion processing mode is a mode in which the wireless communication device 320 communicates with devices such as a smartphone in order to execute the provision of an application for sales promotion by the application providing unit 791.

On the other hand, the missing child search mode is a mode in which the wireless communication device 320 performs short-range wireless communication for a missing child search with a device such as a smartphone that a missile child is carrying (for example, a smartphone, a mobile phone, or a game device).

Normally, the mode setting unit 191 is set to the sales promotion processing mode. On the other hand, upon receiving a missing child search processing request from the registration reception device 400, the mode setting unit 191 switches to the missing child search mode. When the missing child is discovered, the mode setting unit 191 returns to the sales promotion processing mode.

In this exemplary embodiment, in Step S111 of FIG. 2, the state change instruction unit 192, on the basis of the mode set by the mode setting unit 191, instructs the wireless communication device 320 to switch the device of a communication partner.

Also, in Step S112, the determination condition setting unit 291 acquires information of the device which the missing child possesses to set a determination condition for determining whether or not the communication partner is the electronic device. The state change instruction unit 192 acquires information that can identify the device, such as a telephone number in the case of the device being a smartphone or a mobile phone, as information of the device that the missing child possesses.

Moreover, in Step S113, the communication unit 210 receives information that can identify the communication partner of the wireless communication device 320. Here, for example, the missing child search processing device 200, on the basis of information such as the phone number of the missing child, utilizes a device management function via a cloud service to turn ON the Wi-Fi (trademark) function of the device and connect it to the wireless communication device 320.

In Step S114, the determination unit 292 analyzes information obtained in Step S113. In Step S115, the determination unit 292, by comparing the analysis result and the determination condition, determines whether or not the device that the missing child possesses is included in the communication partners of the wireless communication device 320.

Also, in Step S121, the state change instruction unit 192, on the basis of the mode set by the mode setting unit 191, gives an instruction to restore the setting of the electronic device of the missing child (for example, turn OFF the aforementioned Wi-Fi function).

Also, in the output of the missing child location information in Step S122, the display unit 230 displays for example information for identifying the wireless communication device 320 that performed communication with the electronic device that the missing child possesses or the signal strength of communication with the electronic device that the missing child possesses.

As described above, the missing child search system 12 includes the wireless communication device 320 as a sensor device to output data obtained from the wireless signal that was received.

Thereby, in the missing child search system 12, it is possible to use the wireless communication device 320 that performs communication for the sales promotion processing system 22 for the purpose of a missing child search, and it is possible to reduce the cost of separately installing a wireless communication device 320 used for the missing child search system 12.

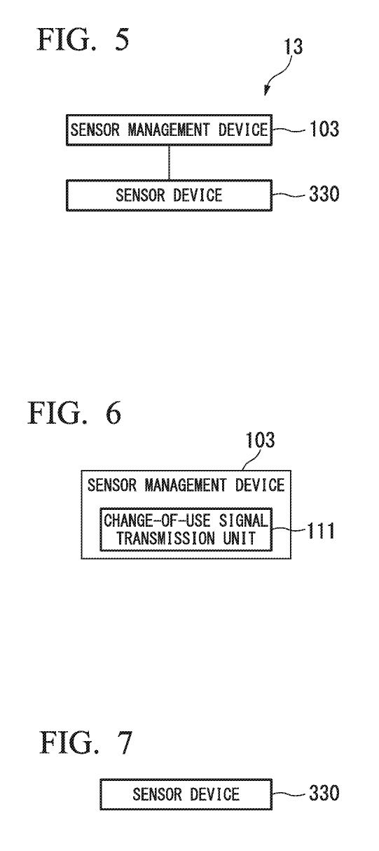

Next, a minimum constitution of the present invention will be described referring to FIG. 5 to FIG. 7.

FIG. 5 is an outline block diagram that shows a minimum configuration of a sensor management system of the present invention. In the same figure, a sensor management system 13 includes a sensor management device 103 and a sensor device 330.

In this constitution, the sensor management device 103 transmits a change-of-use signal to the sensor device 330 when changing the use of the sensor device 330. The sensor device 330 acquires data on the basis of the change-of-use signal.

Thereby, in the sensor management system 13, by switching the state of the sensor device 330 it can be used for a plurality of purposes. Accordingly, according to this sensor management system 13, since there is no need to install a sensor device 330 for each use, it is possible to reduce the cost of installing sensors to be used in the system.

FIG. 6 is an outline block diagram that shows a minimum configuration of a sensor management device of the present invention. In the same figure, a sensor management device 103 includes a change-of-use signal transmission unit 111.

In this constitution, the change-of-use signal transmission unit 111 transmits a change-of-use signal to a sensor device when changing the use of the sensor device.

According to the sensor management device 103, it is possible to change the state of a sensor device in accordance with the use, and it is possible to use a sensor device for a plurality of uses. In this way, according to the sensor management device 103, since there is no need to install a sensor device for each use, it is possible to reduce the cost of installing sensors.

FIG. 7 is an outline block diagram that shows a minimum configuration of a sensor device of the present invention. The same figure shows a sensor device 330.

The sensor device 330, upon receiving a change-of-use signal, acquires data on the basis of the change-of-use signal.

According to the sensor device 330, it is possible to acquire data in accordance with the use. Thereby, it is possible to use the sensor device 330 for a plurality of uses, and since there is no need to install a sensor device for each use, it is possible to reduce the cost of installing sensors.

Note that a program for realizing all of some of the functions of the camera management device 100, the microphone management device 101, the wireless transmission device management device 102, the sensor management device 103, and the missing child search processing device 200 may be recorded on a computer-readable recording medium, and the program recorded in this recording medium may be read and executed with a computer system to perform a process of each unit. Note that the “computer system” cited herein includes an OS and hardware such as peripheral devices.

Also, in the case of utilizing a WWW system, the “computer system” includes a homepage providing environment (or display environment).

Further, the “computer-readable recording medium” includes portable media such as a flexible desk, a magneto-optical disk, ROM, and CD-ROM, and a storage device such as a hard disk that is housed in a computer system.

Further, the “computer-readable recording medium” includes a medium for dynamically storing programs for a short period of time, such as a communication line when a program is transmitted via a network such as the Internet or a communication line such as a telephone line, and a medium that holds a program for a fixed period of time, such as a volatile memory in a computer system serving as a server or client in the above situation.

The aforementioned program may be one for implementing some of the above functions, or the above functions may be implemented in combination with a program already recorded on the computer system.

Exemplary embodiments of the present invention have been described in detail with reference to the drawings. However, specific configurations are not limited to the described exemplary embodiments, and design modifications without departing from the scope of the invention are included.

This application is based upon and claims the benefit of priority from Japanese patent application No. 2014-191432, filed on Sep. 19, 2014, the disclosure of which is incorporated herein in its entirety by reference.

### INDUSTRIAL APPLICABILITY

According to the present invention, it is possible to reduce the cost of installing sensors used in a sensor management system.

### REFERENCE SYMBOLS

10, 11, 12: Missing child search system

13: Sensor management system

20, 21: Marketing processing system

22: Sales promotion processing system

100: Camera management device

101: Microphone management device

102: Wireless communication device management device

103: Sensor management device

110, 210, 710, 810: Communication unit

111: Change-of-use signal transmission unit

180, 280, 780, 880: Recording unit

190, 290, 790, 890: Control unit

191: Mode setting unit

192: State change instruction unit

200: Missing child search processing device

220, 720, 820: Operation input unit

230, 730, 830: Display unit

291: Determination condition setting unit

292: Determination unit

300: Camera

310: Microphone

320: Wireless communication device

330: Sensor device

400: Registration reception device

700: Sales promotion processing device

791: Application providing unit

800: Marketing processing device

891: Marketing information analysis unit

900: Network

1. A sensor management system comprising:
a sensor device; and
a sensor management device,
wherein the sensor management device transmits a change-of-use signal to the sensor device in a case where a use of the sensor device is changed, and
the sensor device acquires data based on the change-of-use signal.

2. The sensor management system according to claim 1, wherein the sensor management device acquires a processing request for instructing the use of the sensor device, and automatically generates the change-of-use signal based on the processing request.

3. The sensor management system according to claim 1, further comprising:
a determination device that acquires determination information, the determination device determining whether data acquired after the sensor device has changed its state by the change-of-use signal satisfies a condition, the condition being set based on the determination information.

4. The sensor management system according to claim 3, further comprising:
a registration reception device that receives an operation of registering the determination information.

5. The sensor management system according to claim 1, wherein the sensor device includes a camera and outputs image data.

6. The sensor management system according to claim 1, wherein the sensor device includes a microphone and outputs audio data.

7. The sensor management system according to claim 1, wherein the sensor device includes a wireless receiver and outputs data obtained from a wireless signal received by the wireless receiver.

8. A sensor management device comprising:
a change-of-use signal transmission unit that transmits a change-of-use signal to a sensor device in a case where a use of the sensor device is changed.

9. A sensor device that, upon receiving a change-of-use signal instructing a change of use, acquires data based on the change-of-use signal.

10-11. (canceled)
